(19) United States
(12) Patent Application Publication
(10) Pub. No.: US 2026/0204909 A1
(43) Pub. Date: Jul. 16, 2026

(54) METHODS AND SYSTEMS FOR CONTROLLING A POWER PLANT DURING NETWORK FREQUENCY FLUCTUATIONS WITHIN A FREQUENCY CONTINGENCY DEADBAND

(71) Applicant: VESTAS WIND SYSTEMS A/S, Aarhus N (DK)

(72) Inventors: Mu WEI, Solbjerg (DK); Brian W. ANDERSEN, Ringkøbing (DK); Henrik MØLLER, Egå (DK); Joel IGBA, Hamburg (DE); Kennet Kirk JENSEN, Holstebro (DK); Kouroush NAYEBI, Ikast (DK); Leif Svinth CHRISTENSEN, Ikast (DK); Lennart BELAND, Silkeborg (DK); Luis Carlos Perez MARTINEZ, Hinnerup (DK); Andreas SVENDSTRUP-BJERRE, Aarhus N (DK)

(21) Appl. No.: 19/129,597

(22) PCT Filed: Nov. 13, 2023
(86) PCT No.: PCT/DK2023/050275

§ 371 Date: May 13, 2025

(30) Foreign Application Priority Data
Nov. 15, 2022 (DK) PA202270558

(51) Int. Cl. H02J 3/17; H02J 3/0014; H02J 3/32; H02J 3/38; H02J 101/24; H02J 101/28; H02J 101/40

(52) U.S. Cl. CPC H02J 3/17; H02J 3/00142; H02J 3/32; H02J 3/381; H02J 2101/24; H02J 2101/28; H02J 2101/40

(57) ABSTRACT

According to an aspect of the present invention there is provided a method of controlling a renewable energy power plant to provide frequency regulation for a power network, to which the power plant is connected The power plant comprises a plurality of power units operable to provide upregulation and/or downregulation of the power network. The method comprises: receiving a measured frequency level of the power network indicative of a frequency deviation within a frequency contingency deadband of the power network; identifying a sub-band of the frequency deviation, from amongst a plurality of sub-bands within the frequency contingency deadband, based on the measured frequency level; identifying one or more power units authorized for at least one frequency regulation service within the identified sub-band; determining a deliverable power offset from a baseline power level for each authorised power unit, the deliverable power offset being based, in part, on the at least one authorised frequency regulations service; and determining and dispatching power set points to the one or more authorised power units to satisfy a plant power offset request for the measured frequency level. The set points are determined by: selecting one or more of the authorised power units to provide the deliverable power offset determined for that power unit, wherein a cumulative power offset of the one or more selected power units is less than or equal to the plant power offset request; and if there is a power shortage between the plant power offset request and the cumulative power offset, determining set points for the remaining authorised power units to satisfy the power shortage.

### TECHNICAL FIELD

The present disclosure relates to methods and systems for controlling a power plant to provide frequency regulation services, in particular frequency regulation services within a frequency contingency deadband of a power network to which the power plant is connected. Aspects of the invention relate to a method, and to a power plant controller.

### BACKGROUND

Regulators and operators of power networks expect connected power plants to adhere to a ‘grid code’and to provide particular services to the power network.

For example, national or international power networks have a nominal frequency, also referred to as the utility or mains frequency, which is typically 50 Hz or 60 Hz. Some operators require power plants to support the power network when the frequency of the power network deviates from a normal operational range around the nominal frequency, also referred to as a frequency contingency deadband. Such changes in frequency are undesirable, as equipment to which power is supplied is configured to operate at a particular frequency with a relatively tight tolerance. Thus, where frequency deviates from the nominal frequency, even by less than 1 Hz, it is important to take corrective measures quickly.

In some cases, power plant operators offer frequency regulation services, such as a frequency containment reserve (FCR), to further improve grid stability even while the network frequency remains within the frequency contingent deadband. For example, a power plant operator may agree to provide upregulation and/or downregulation services to counteract deviations from the nominal operating frequency of the power network in an hourly, daily, or yearly market. In this context, upregulation means increasing power supply or decreasing power consumption of the power plant, while downregulation means decreasing power supply or increasing consumption of the power plant.

More recently, it has become possible for individual power units, such as individual energy generators, energy consumers and/or energy stores of a power plant, to offer different frequency regulation services within the frequency contingency deadband. In particular, it may be agreed for individual power units to counteract frequency deviations within one or more sub-bands of the frequency contingency deadband. However, this range of options increases the control complexity.

It is an aim of the present invention to address one or more of the disadvantages associated with the prior art.

### SUMMARY OF INVENTION

According to an aspect of the present invention there is provided a method of controlling a renewable energy power plant to provide frequency regulation for a power network, to which the power plant is connected. The power plant comprises a plurality of power units operable to provide upregulation and/or downregulation of the power network. The method comprises: receiving or obtaining a (measured) frequency level of the power network indicative of a frequency deviation within a frequency contingency deadband of the power network; identifying a sub-band of the frequency deviation, from amongst a plurality of sub-bands within the frequency contingency deadband, based on the (measured) frequency level; identifying one or more power units authorized for at least one frequency regulation service within the identified sub-band; determining a deliverable power offset from a baseline power level for each authorised power unit, the deliverable power offset being based, in part, on the at least one authorised frequency regulations service; and determining and dispatching power set points to the one or more authorised power units to satisfy a plant power offset request for the (measured) frequency level. The set points are determined by: (i) selecting one or more of the authorised power units to provide the deliverable power offset determined for that power unit, wherein a cumulative power offset of the one or more selected power units is less than or equal to the plant power offset request; and (ii) if there is a power shortage between the plant power offset request and the cumulative power offset, determining set points for the remaining authorised power units to satisfy the power shortage.

In this manner, the method reduces the control complexity associated with controlling the power plant to provide frequency regulation services within the frequency contingency deadband, whilst facilitating the agreement of a range of frequency regulation services for individual power units of the power plant.

The deliverable power offset may, for example, be determined as a minimum of: a prescribed power offset for that power unit and a possible power offset for that power unit. In this context, the prescribed power offset may be based on the at least one authorised frequency regulation service and the measured frequency level, for example. The possible power offset may, for example, be the difference between the baseline power level for that power unit and an upper and/or lower limit of available power for that power unit.

Optionally, each power unit may be authorised for one or more of a plurality of frequency regulation services. Each frequency regulation service may be associated with prescribed power offsets for respective frequency levels within one or more of the plurality of sub-bands. In this manner, individual power units may be controlled to provide different frequency regulation services.

The plurality of frequency regulation services may, for example, include one or more of: (i) a Frequency Containment Reserve for Normal Operation (FCR-N) in response to frequency deviations below a nominal frequency level of the power network; (ii) a FCR-N in response to frequency deviations above the nominal frequency level; (iii) a Frequency Containment Reserve for Disturbances (FCR-D) in response to frequency deviations below the nominal frequency level; (iv) a FCR-D in response to frequency deviations above the nominal frequency level; and/or (v) a combination of two more selected from (i) to (iv).

Optionally, each frequency regulation service is associated with a respective Power-frequency (P-f) curve. For example, the method may further comprises determining the prescribed power offset for each authorised power unit based on the P-f curve associated with the at least one authorised frequency regulation service.

In an example, each frequency regulation service (e.g. each of the FCR-N and FCR-D frequency regulation services) may be associated with a respective P-f offset curve from a baseline power level in a respective sub-band of the frequency contingency deadband. Optionally, combinations of the frequency regulation services are associated with respective P-f curves (e.g. combinations of the FCR-N and/or FCR-D frequency regulation services may be associated with respective P-f curves). For example, the respective P-f curves may be determined by summing the respective P-f offset curves of the combined FCR-N and/or FCR-D frequency regulation services.

Each power unit may, for example, be authorised for the one or more frequency regulation services for a respective service period. In this manner, different frequency regulation services may be agreed for different periods, providing a more flexible operation.

Optionally, the method further comprises determining the prescribed power offset for each authorised power unit based on a respective agreed maximum contribution to the at least one authorised frequency regulation service. The maximum contribution to the at least one authorised frequency regulation service may, for example, be agreed for a prescribed service period. For example, the maximum contribution may be set or determined according to various factors, including the fatigue life or age of a power unit, for example.

Optionally, the method further comprises determining the possible power offset for the power unit based on the baseline power level for that power unit and the upper and/or lower limit of available power for that power unit.

In an example, the one or more authorised power units may be selected by: ranking the one or more authorised power units in a priority list based on the deliverable power offset determined for each authorised power unit; and selecting the 1 to M highest ranked power units, where M is a positive integer. In this manner, the method may ensure that power units authorised to provide the greatest contribution are prioritised in the response.

Optionally, M is a maximum positive integer for ensuring that the cumulative power offset of the one or more selected power units is less than or equal to the plant power offset request.

In an example, the plurality of power units may include: one or more renewable energy generators, such as a wind turbine generator; one or more energy stores, such a battery unit; and/or one or more energy consumers, such as an electrolyser and/or a chemical plant.

According to another aspect of the invention, there is provided a computer-readable storage medium comprising instructions that, when executed by a computer, cause the computer to perform the method described above.

According to a further aspect of the invention there is provided a power plant controller configured to perform the method described in a previous aspect of the invention.

Within the scope of this invention it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows schematically a power network connected to a renewable energy power plant that includes a power plant controller;

FIG. 2 shows a system diagram of a control module, in accordance with an embodiment of the invention, of the power plant controller of FIG. 1;

FIG. 3 shows exemplary P-f curves of the control module of FIG. 2;

FIG. 4 shows an exemplary method of controlling the power plant shown in FIG. 1, in accordance with an embodiment of the invention; and

FIG. 5 shows exemplary functional components of the power plant controller shown in FIG. 1.

### DETAILED DESCRIPTION

Generally, the present invention relates to methods and systems for controlling a renewable energy power plant to provide frequency regulation for a connected power network while the frequency level remains within a frequency contingency deadband of the power network.

The renewable energy power plant includes a plurality of power units, which may include one or more power generators, power consumers, and/or power stores, operable to provide upregulation and/or downregulation of the power network. Each power unit is therefore operable to counteract frequency deviations within the frequency contingency deadband.

However, the power units may be authorised, configured, or controlled, to provide different frequency regulation services within the frequency contingency deadband. In particular, each power unit may be authorised, configured, or controlled, to provide one or more frequency regulation services, where each frequency regulation service defines respective power offsets from a baseline power level for the authorised power units when the frequency level deviates within one or more respective sub-bands of the frequency contingency deadband. To give an example, a battery unit of the power plant may be authorised to provide a Frequency Containment Reserve for Normal Operation (FCR-N) when the frequency level reduces from the nominal operating frequency into a respective sub-band of the frequency contingency deadband. Accordingly, the power level of that battery unit may therefore be adjusted or offset from a baseline power level to counteract frequency deviations within the respective frequency sub-band.

As individual power units are authorised to provide respective frequency regulation services within the frequency contingency deadband, the individual power units are therefore configured to provide different power offsets in dependence on the frequency level of the power network.

Advantageously, the methods and systems of the present invention are configured to receive a measured frequency level of the power network (indicative of a frequency deviation within the frequency contingency deadband), identify which sub-band the frequency level has deviated into and, in turn, identify one or more power units that are authorized to provide a frequency regulation service within that frequency sub-band. Based on this identification, the methods and systems further determine respective power offsets that are deliverable from each of the authorised power units to counteract the frequency deviation. In particular, the deliverable power offset from each power unit is an offset from a respective baseline power level of that power unit, which may correspond to the prescribed, frequency-dependent, offset of the frequency regulation service or a maximum possible offset that the power unit is able to provide in view of the prevailing operating conditions.

In order to counteract the frequency deviation, a plant power offset request is received or otherwise determined by the system, which specifies a total power offset from a baseline power level of the power plant to counteract the frequency deviation. Accordingly, the methods and system of the present invention determine and dispatch set points to the authorised power units to cumulatively satisfy the plant power offset request. In this respect, the set points are determined and dispatched to ensure that: (i) a selection of the authorised power units deliver the respective power offsets and (ii) the remaining authorised power units reduce or resolve any outstanding shortage between the plant power offer offset request and the cumulative power offset provided by the selected power units.

Accordingly, the authorised power units can be operated to provide agreed frequency regulation services and the frequency deviation can be counteracted by the cumulative power offset. In this manner, it is expected that the methods and system of the present invention will provide for enhanced grid stability and improved operational flexibility, allowing wider adoption of frequency regulation services within the frequency contingency deadband.

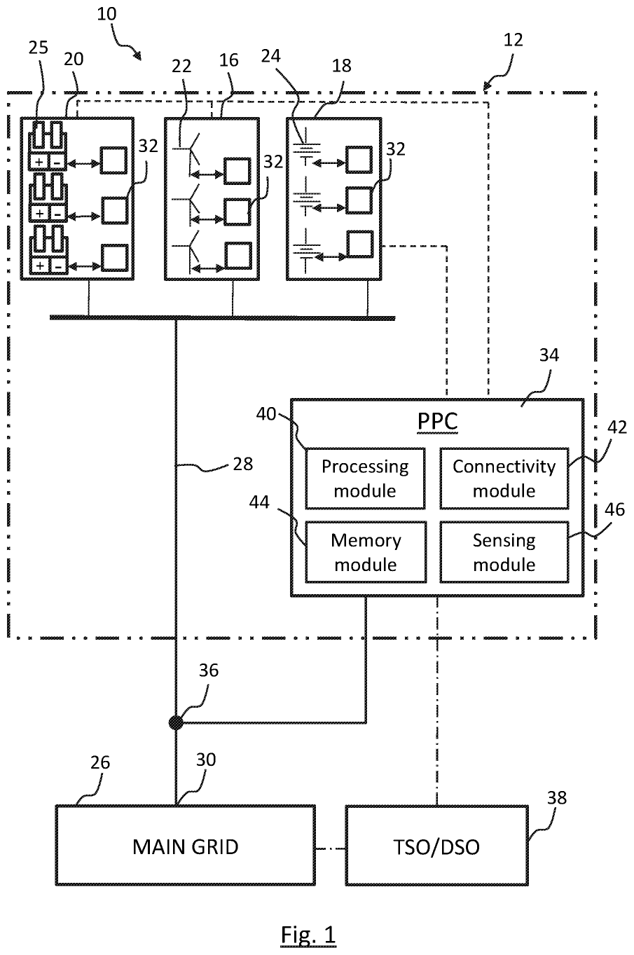

FIG. 1 illustrates an example architecture in which a renewable energy power plant (PP) is connected to a main grid or power network. The PP includes a plurality of power units for providing frequency regulation services to the connected power network while the frequency level of the power network remains within a normal operational range around a nominal frequency. Each power unit is capable of providing upregulation and/or downregulation to counteract frequency deviations and takes the role of a power generator or supplier; a power consumer or receiver; or a power store. The PP may comprise a single type of power unit or the PP may take the form of a hybrid power plant (HPP), as in this example, which comprises at least two different types of power units, specifically electrolysers of an electrolysis system, wind turbine generators (WTG)s of a wind power system, and battery units of an energy storage system.

The examples shown in the figures are representative only though and the skilled reader will appreciate that other specific architectures of renewable energy power plants are possible. For example, it is possible that the PP may feature any one type of power unit or the renewable energy power plant may be configured as a hybrid power plant having two or more types of power unit incorporated as respective power generating, power consuming, or power storing systems.

Furthermore, it will be understood by the skilled reader that each such system of the PP may be formed by a single power unit. Therefore, as each power system may comprise a single power unit and a hybrid power plant requires two or more power systems, a hybrid power plant may be defined as a power plant incorporating at least two power units that generate power from different sources of renewable energy, consume power for different applications and/or store power in different forms. Moreover, while an electrolysis system, a wind power system and a battery energy storage system are discussed herein, it will also be appreciated that other forms of power units may also be included in the renewable energy power plant as appropriate. For example, it is anticipated that power generating systems may include wind power systems and/or photovoltaic systems; power consuming system may include electrolysis systems, chemical plants and/or thermal energy systems; and energy storage systems may include battery energy storage systems amongst other forms of energy storage.

The skilled reader will appreciate that the methods, systems and techniques also described below may be applicable to many different configurations of power network. Moreover, the components of the renewable energy power plant and power network are conventional and as such would be familiar to the skilled reader. It is expected that other known components may be incorporated in addition to or as alternatives to the components shown and described in FIG. 1. Such changes would be within the capabilities of the skilled person.

Considering FIG. 1 in more detail, a power system 10 incorporates the PP 12. The PP 12 includes the wind power system 16, the battery energy storage system 18, the electrolysis system 20, and a power plant controller 34, referred to hereafter as PPC 34. The wind power system 16 comprises a plurality of wind turbine generators (WTGs) 22 configured to convert wind energy into electrical energy. The battery energy storage system 18 comprises one or more battery units 24, in particular rechargeable batteries, providing centralised or semi-centralised energy stores for the PP 12. For example, the battery energy storage system 18 may include a plurality of electrochemical batteries, such as lithium-ion batteries and/or solid-state batteries for example, operable to store and release electrical energy as required. The electrolysis system 20 comprises one or more electrolysers 25 configured to generate hydrogen using electrical energy. For example, the electrolysis system 20 may form part of a wider hydrogen generation system for producing hydrogen gas. Single WTGs 22, battery units 24, and/or electrolysers 25 would also be possible in each of these systems 16, 18, 20.

The PP 12 is connected to a main grid 26 (also called a main power network) via a connecting network 28. The PP 12 and the main grid 26 are connected at a Point of Interconnection (Pol) 30, which is an interface between the PP 12 and the main grid 26. It should be assumed that references to components being connected or connections between components comprise suitable feeder or transmission lines unless it is otherwise indicated.

Electrical energy supplied from the wind power system 16 and/or the energy storage system 18 may be transferred to the electrolysis system 20 for hydrogen production and/or to the main transmission network or main grid 26, via the connecting network 28, as active current, for distribution. Electrical energy may also be transferred from the wind power system 16 and/or the main grid 26 to the electrolysis system 20 and/or to the energy storage system 18 for storage. In this manner, each system 16, 18, 20 is operable to provide both upregulation and downregulation in response to frequency deviations, in particular, by offsetting an active power level (positively or negatively) from a baseline power level for the nominal frequency.

Each of the WTGs 22, the battery units 24, and/or the electrolysers 25 within the systems 16, 18, 20 of FIG. 1 is associated with a respective controller, generally labelled 32. In some embodiments, a sub-set of the WTGs 22, the battery units 24, and/or the electrolysers 25, may share a single, semi-centralised controller, such that there are fewer controllers than power units (a ‘power unit’ being a reference to a single WTG 22, battery unit 24, or electrolyser 25 in this context). As would be apparent to the skilled person, the controllers 32 can be considered to be computer systems capable of operating the WTGs 22, the battery units 24, and/or the electrolysers 25 in the manner prescribed herein, and may comprise multiple modules that control individual components of each power unit 22, 24, 25.

During normal operation of the PP 12, the controllers 32 operate the WTGs 22 and/or battery units 24 to implement active and reactive current, and/or power, set points received from the PPC 34. In this manner, the WTGs 22 and/or battery units 24 provide frequency and voltage support to the main grid 26. The controllers 32 may also operate the electrolysers 25 to implement active current, and/or power, set points received from the power plant controller PPC 34 to draw power from the WTGs 22 and/or battery units 24 to produce hydrogen.

For this purpose, the PPC 34 is connected to the power network 10 at a Point of Measurement (POM) 36 and is also connected to each of the systems 16, 18, 20 of the PP 12, for example via the controllers 32. For example, the PPC 34 may be configured to receive one or more measurement signals from the PoM 36 comprising measurements of the power supply from the PP 12 to the main grid 26 and/or a frequency level of the main grid 26 and determine and dispatch corresponding set points to the controllers 32. The PPC 34 may also receive information regarding the grid 26 and/or connecting network 28 from an energy management system (not shown) or by direct measurement.

In this respect, the role of the PPC 34 is to act as a command and control interface between the PP 12 and the grid 26, and more specifically, between the systems 16, 18, 20 and a grid operator or transmission system operator (TSO) 38.

The skilled person shall appreciate that the PPC 34 is therefore a suitable computer system for carrying out the controls and commands as described herein and so may incorporate a processor 40, a connectivity module 42, a memory module 44, and a sensing module 46.

During normal operation, the frequency level of the connected main grid 26 may deviate from a nominal operating frequency of the grid 26, within a normal operating range or frequency contingency deadband. The frequency contingency deadband is generally a small region around the operating frequency. For example, the nominal operating frequency is typically 50 Hz, or in some examples 60 Hz, as measured at the Pol 30 or PoM 36, and upper and lower frequency limits of the frequency contingency deadband may be +/−0.5 Hz.

The deviations typically occur because of an imbalance of power generation and power consumption in the grid 26 or in response to a grid fault, for example, and the PP 12 may provide primary frequency regulation services, including frequency containment reserve (FCR) services, to counteract deviations from the nominal operating frequency within the frequency contingency deadband.

Typically, a power plant may be operated to provide such frequency regulation services for a limited service period. For example, the power plant operators may offer capacity, and fulfil the reserve requirements, for a yearly, daily, and/or hourly market. Hence, the power plant operator may agree to provide such a frequency regulation service for a 24-hour period (though this example is not intended to be limiting on the scope of the invention).

Accordingly, even while the network frequency remains within the frequency contingency deadband, the power plant operator may support the network by upregulation or downregulation based on a deviation of the current frequency from the network's nominal operating frequency.

In the methods and systems of the present invention, individual power units 22, 24, 25 may be operated to provide respective frequency regulation services within the frequency contingency deadband. For example, individual power units 22, 24, 25 may offer capacity, and agree to fulfil respective frequency regulations services, for a respective service period.

In particular, individual power units 22, 24, 25 can be authorised to provide respective frequency regulation services that define how the power level of that power unit should be adjusted or offset from respective baseline power levels to counteract the frequency deviation within one or more sub-bands of the frequency contingency deadband.

The PPC 34 is therefore configured to manage the power units 22, 24, 25 according to the agreed frequency regulation services and to determine and dispatch corresponding set points to cumulatively counteract the frequency deviation.

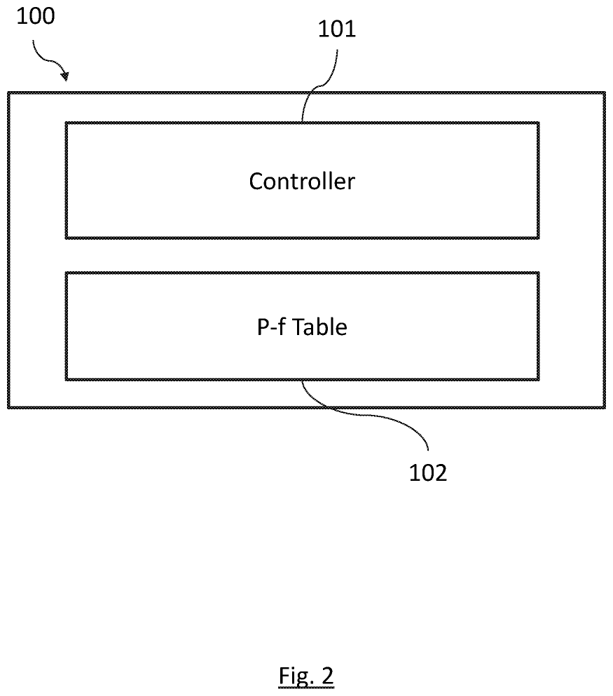

For this purpose, FIG. 2 illustrates a frequency regulation control scheme, algorithm, or “controller” 100, which forms part of the processing module 40 of the PPC 34 for determining and dispatching set points to the power units 22, 24, 25 during a frequency regulation service period.

The controller 100 is configured to receive a measured frequency level of the connected main grid 26, indicative of a frequency deviation within a frequency contingency deadband of the grid 26, and to identify which sub-band the frequency level has deviated into.

Once the controller 100 has identified which sub-band the frequency deviation falls within, the controller 100 further identifies one or more power units 22, 24, 25 that have been authorised to provide a respective frequency regulation service in that sub-band. For example, the controller 100 may receive a participants list or instructions for each service period from the power plant operator, where the instructions indicate agreed frequency regulation services for each of the power units 22, 24, 25. The controller 100 may therefore compare respective sub-bands of those frequency regulation services to the frequency deviation in order to identify the power units 22, 24, 25 that are authorised to counteract the frequency deviation.

The authorised power units 22, 24, 25 are therefore controllable to counteract the frequency deviation by increasing or decreasing the power level of each power unit 22, 24, 25 from a respective baseline power level for the nominal operating frequency. For example, in response to a frequency deviation above the nominal operating frequency, the power level of each authorised power unit 22, 24, 25 may be reduced, for example by curtailing a power supply from the WTGs 22, increasing the power consumption of the electrolysers 25, and/or reducing a power supply from/increasing a power supply to the battery units 24. Conversely, in response to a frequency deviation below the nominal operating frequency, the power level of each authorised power unit 22, 24, 25 may be increased, for example by using a spinning reserve of the WTGs 22, reducing the power consumption of the electrolysers 25, and/or increasing a power supply from/reducing a power supply to the battery units 24.

Each frequency regulation service is associated with a prescribed power offset for a respective frequency level within the respective one or more sub-bands. The controller 100 may therefore include one or more look-up tables 102, as shown in FIG. 2, for determining the prescribed power offset of each authorised power unit for respective frequency level measurements, and/or pre-determined ramp rates for increasing or decreasing the power level.

In particular, the look-up table 102 may include a plurality of Power-frequency (P-f) curves associated with respective frequency regulation services within the frequency contingency deadband. For example, the look-up table 102 may include a respective P-curve for the following frequency regulation services:
(i) A Frequency Containment Reserve for Normal Operation (FCR-N) in response to frequency deviations below the nominal frequency level;
(ii) a FCR-N in response to frequency deviations above the nominal frequency level;
(iii) a Frequency Containment Reserve for Disturbances (FCR-D) in response to frequency deviations below the nominal frequency level;
(iv) a FCR-D in response to frequency deviations above the nominal frequency level; and/or
(v) any combination of such services.

Each P-f curve may define a power offset from a baseline frequency curve for the measured frequency level, such that the frequency level measurement, (f), can be matched to a respective active power target value, P(f) or active power offset.

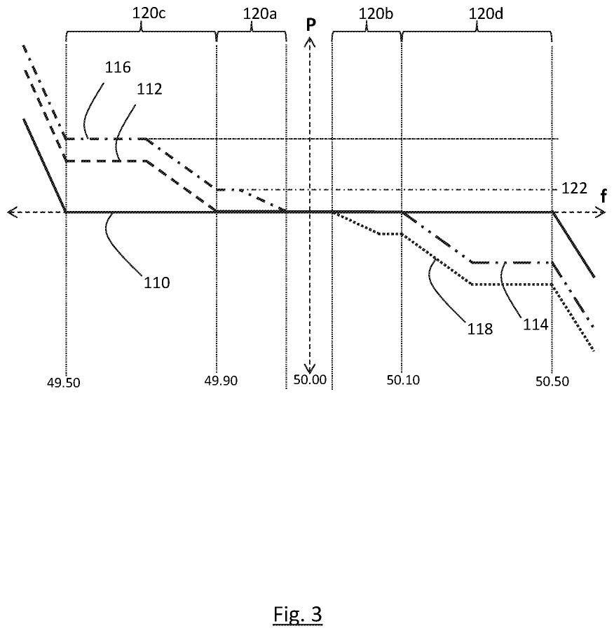

By way of illustration, P-f curves of the type that the skilled person will be familiar with are shown in FIG. 3.

A first P-f curve 110 shows a baseline frequency curve of the power plant for the nominal frequency level. A second P-f curve 112 shows an example P-f curve produced by the FCR-D service in response to frequency deviations below the nominal frequency level. A third P-f curve 114 shows an example P-f curve produced by the FCR-D service in response to frequency deviations above the nominal frequency level. A fourth P-f curve 116 shows an example P-f curve produced by the combination of the FCR-N services and the FCR-D services in response to frequency deviations below the nominal frequency level. A fifth P-f curve 118 shows an example P-f curve produced by the combination of the FCR-N services and the FCR-D services in response to frequency deviations above the nominal frequency level.

Considered in more detail, the first P-f curve 110 (representing a baseline frequency curve) shows a frequency deadband, DB, defining a frequency range over which the active power target value, P(f), is substantially constant. The example P-f curve also shows a prescribed increase in the active power target value, P(f), when the frequency level falls below the frequency deadband, DB, and a prescribed decrease in the active power target value, P(f), when the frequency level rises above the frequency deadband, DB.

The second, third, fourth, and fifth P-f curves 112, 114, 116, 118 each show the frequency deadband, DB, split into first, second, third and fourth sub-bands 120a-d in this example. The second and third P-f curves 112, 114 are substantially constant over the first and second sub-bands 120a-b and correspond to the baseline P-f curve in such areas. However, an offset curve is applied to the baseline frequency curve in the third sub-band 120c of the second P-f curve 112 (corresponding to the FCR-D service for frequency deviations below the nominal frequency level). Accordingly, when the frequency level reduces into the third frequency sub-band 120c, (during a frequency deviation below the nominal frequency level) there is a prescribed decrease in the active power target value, P(f). Similarly, an offset curve is applied to the baseline frequency curve in the fourth sub-band 120c of the third P-f curve 116 (corresponding to the FCR-D service for frequency deviations above the nominal frequency level). Accordingly, when the frequency level increases into the fourth frequency sub-band 120d, (during a frequency deviation above the nominal frequency level), there is a prescribed decrease in the active power target value, P(f).

In the fourth P-f curve 116 (corresponding to a combination of the FCR-N and FCR-D services for frequency deviations below the nominal frequency level) an offset curve is applied to the baseline frequency curve in the first sub-band 120a. Accordingly, when the frequency level reduces from the nominal operating frequency into the first frequency sub-band 120a, (during a frequency deviation below the nominal frequency level) there is a prescribed decrease in the active power target value, P(f). Furthermore, in the third frequency sub-band 120c, the offset curve associated with the FCR-D service (for responding to frequency deviations below the nominal frequency level) is further applied to the active target power value P(f), combining the FCR-N and FCR-D frequency responses. Accordingly, there is a further prescribed increase in the active target power value P(f) when the frequency level drops from the first frequency sub-band 120a to the third frequency sub-band 120c.

Similarly, in the fifth P-f curve 118 (corresponding to a combination of the FCR-N and FCR-D services for frequency deviations above the nominal frequency level), an offset curve is applied to the baseline frequency curve in the second sub-band 120b. Accordingly, when the frequency level increases from the nominal operating frequency into the second frequency deadband 120b, DB, (during a frequency deviation above the nominal frequency level), there is a prescribed decrease in the active power target value, P(f). Furthermore, in the fourth frequency sub-band 120d, the offset curve associated with the FCR-D services (for responding to frequency deviations above the nominal frequency level) is further applied to the active target power value P(f) combining the FCR-N and FCR-D frequency responses. Accordingly, there is a further prescribed decrease in the active target power value P(f) when the frequency level increases from the second frequency sub-band 120b to the fourth frequency sub-band 120d.

Accordingly the controller 100 may receive the measured frequency level, identify which of the first to fourth sub-bands 120a-d the frequency deviation is within and thereby identify respective ones of the power units 22, 24, 25 authorised for providing frequency regulation services in response. For example, the controller 100 may determine that the frequency deviation is within the first frequency sub-band 120a and therefore identify any power units 22, 24, 25 that are authorised to provide the FCR-N service in response to frequency deviations in the first sub-band 120a. For each of the authorised power units 22, 24, 25, the controller 100 can therefore determine a prescribed power offset from the fourth P-f curve 118, shown in FIG. 3, based on the measured frequency level.

If the measured frequency level were subsequently to reduce further into the third sub-band 120c, the controller 100 would redetermine the authorised power units 22, 24, 25 and identify those power units 22, 24, 25 that are authorised to provide the FCR-N service, or a combination of the FCR-N service and the FCR-D service, in response to frequency deviations below the nominal frequency level. The controller 100 can therefore determine a prescribed power offset for each of the authorised power units 22, 24, 25, from one of the first P-f curve 112 and the third P-f curve 116 respectively.

The controller 100 may therefore determine the prescribed power offset for each power unit 22, 24, 25 using one or more of the P-f curves.

In some examples, in addition to authorising individual power units 22, 24, 25 to provide respective frequency regulations services, the power plant operator may also agree to provide maximum power contributions to such services. In examples, the prescribed power offset may therefore be determined using the P-f curve subject to any specific maximum power contributions to the frequency regulation service for that power unit 22, 24, 25. For example, the power plant operator may only agree to provide up to a maximum power contribution of 2 MW to a particular frequency regulation service and the prescribed power offset may therefore be determined with reference to the one or more P-f curves up to the maximum power contribution of 2 MW.

Moreover, although the frequency regulation services may prescribe respective power offsets for the power units 22, 24, 25, the operating conditions may limit the extent of power adjustment from the baseline power level that each power unit 22, 24, 25 can provide.

In other words, in view of the operating conditions, each power unit 22, 24, 25 is only capable of providing a respective maximum possible power offset from the baseline power level of the nominal operating frequency. The maximum possible power offset for each power unit 22, 24, 25 corresponds to the difference between the baseline power level and an upper/lower limit of available power. For example, the WTGs 22 can only increase the power level from the baseline level to an available power level in view of the current wind speed. Similarly, the battery units 24 have a limited energy store and upper/lower limits may therefore be applied to the transfer of available power.

To take this into account, the controller 100 is configured to determine a deliverable power offset for each power unit 22, 24, 25 from its respective baseline power level, where the deliverable power offset corresponds to the lesser one of (i) the prescribed, frequency-dependent, offset of the frequency regulation service and (ii) a maximum possible offset that the power unit is able to provide in view of the operating conditions. The PPC 34 can therefore determine set points for each of the authorised power units 22, 24, 25 based on the deliverable power offsets, which may be dispatched to the respective power unit controllers 32 to counteract the frequency deviation, as shall be discussed in more detail below.

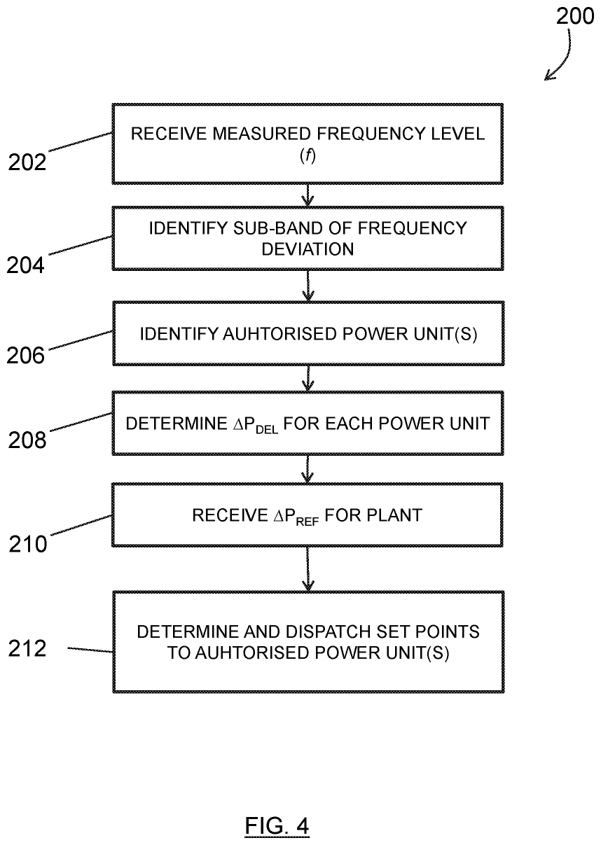

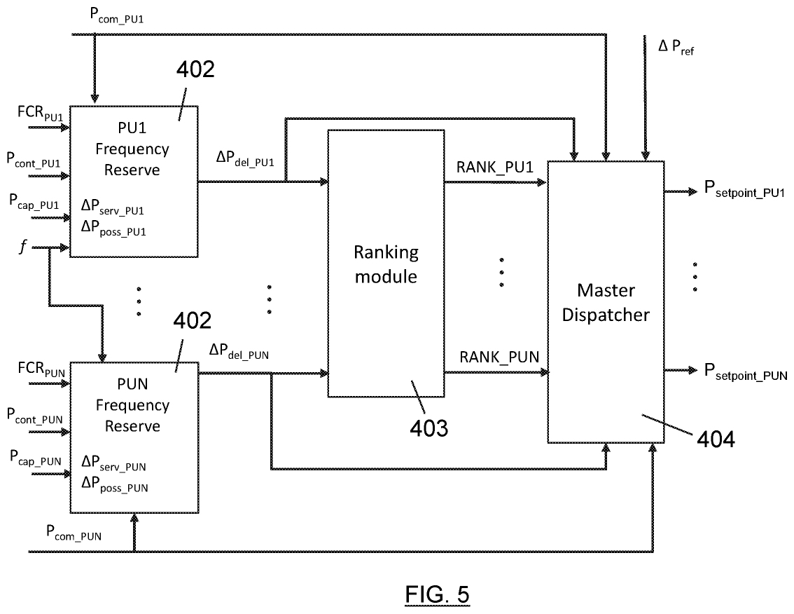

The operation of the PP 12 to provide frequency regulation within the frequency contingency deadband shall now be described with additional reference to FIGS. 4 and 5.

For example, the power plant operator may have agreed to fulfil the reserve requirements of the main grid 26 for a particular service period, such as a period of 24 hours. For this service period, the power plant operator may have authorised one or more of the power units 22, 24, 25 to provide respective frequency regulation services within the frequency contingency deadband. Moreover, in some instances, the power plant operator may have agreed maximum power contributions of such power units 22, 24, 25 to the respective frequency regulation services. For example, the power plant operator may have agreed to provide a maximum power contribution of 2 MW from one of the WTGs 22 for an FCR-N service in response to respective frequency deviations below the nominal frequency level. Such agreements and authorisations may be updated or changed for each service period, producing a set of instructions for the PPC 34.

During the service period, the PPC 34 therefore controls the power units 22, 24, 25 at the baseline power level to satisfy a plant power refence during normal operation. However, if the frequency level deviates from the nominal operating frequency within the frequency contingency deadband, the PPC 34 is configured to determine and dispatch set points to adjust the power level of the power units 22, 24, 25 and provide frequency regulation services.

FIG. 4 shows an example method 200 of controlling the PP 12 to provide such frequency regulation services during the service period.

In step 202, the PPC 34 receives a measurement of the frequency level of the main grid 26. In this instance, the measured frequency level indicates a deviation from the nominal operating frequency (e.g. 50 Hz) of the main grid 26 within the frequency contingency deadband.

In step 204, the PPC 34 identifies which one of a plurality of sub-bands 116a-d the deviation falls within. In particular, continuing the examples above (which are not intended to be limiting on the scope of the invention), the PPC 34 may identify whether the frequency level of the main grid 26 has deviated into one of the first to fourth sub-bands 120a-d of the frequency contingency deadband, shown in FIG. 3. To give an example, the PPC 34 may identify that a frequency deviation below the nominal frequency level has occurred and, specifically, that the frequency level has fallen into the first frequency sub-band 120a.

In step 206, the PPC 34 determines which of the power units 22, 24, 25 are authorised to provide a frequency regulation service in the identified sub-band (120a in this example). For this purpose, the PPC 34 may, for example, recall a participants list or instructions received from the power plant operator, indicating agreed frequency regulation services for each of the power units 22, 24, 25 for the service period.

By way of example, the PPC 34 may therefore identify any of the power units 22, 24, 25 that have been authorised to provide FCR-D services in response to frequency deviations within the first frequency sub-band 120a. This may, for example, include one or more WTGs 22, battery units 24, or electrolysers 25 that have agreed to increase the power supply and/or decrease the power consumption to upregulate the frequency of the main grid 26 when it falls into the first sub-band 120a.

In step 208, the PPC 34 determines the power offset that is deliverable from each of the authorised power units 22, 24, 25 to counteract the frequency deviation.

As mentioned previously, the deliverable power offset is the offset that each authorised power unit 22, 24, 25 is able to provide from its baseline power level and may therefore correspond to: (i) the prescribed offset of the frequency regulation service for the measured frequency level, (ii) an agreed maximum contribution of the power unit 22, 24, 25 to that service, or (iii) a maximum possible offset, where the power unit 22, 24, 25 is unable to provide either the prescribed offset or the maximum contribution thereto.

In particular, the PPC 34 may therefore determine the deliverable power offset for each authorised power unit 22, 24, 25 as a minimum of:
(i) the prescribed power offset of that power unit 22, 24, 25 for the frequency regulation service, including any agreed maximum power contributions of that power unit 22, 24, 25 to that frequency regulation service; and
(ii) the possible power offset of the power unit 22, 24, 25, taking into account the baseline power level and respective upper/lower limits of available power.

The PPC 34 may, for example, be configured to determine the prescribed power offset using the one or more look-up tables 102. For example, the PPC 34 may use one or more P-f curves, such as the exemplary second, third, fourth and fifth P-f curves 112, 114, 116, 118 shown in FIG. 3, to determine the prescribed power offsets associated with respective frequency regulation services.

Continuing the previous example, the PPC 34 may therefore use the third P-f curve 116 (corresponding to the FCR-D service for a frequency deviation below the nominal frequency level) to determine the prescribed power offsets for each of the authorised power units 22, 24, 25 within the first frequency sub-band 120a. Hence, as the measured frequency level reduces from an upper limit to a lower limit of the first frequency sub-band 120a, the PPC 34 may determine respective set points ramping the power level of each authorised power unit 22, 24, 25 down from the baseline power level to a first offset 122 from the baseline power level. However, if a maximum power contribution has been agreed for one or more of the authorised power units 22, 24, 25, then the prescribed power offset may instead be capped or limited at a second offset from the baseline power level before reaching the first offset 122.

In examples, the PPC 34 may receive or otherwise determine the possible power offset of each authorised power unit 22, 24, 25 according to various methods that are known in the art. For example, in relation to the WTGs 22, the PPC 34 may receive an available power level or a maximum amount of curtailment for each WTG 22 and thereby determine a respective possible power offset (to counteract the frequency deviation) by comparison to the baseline power level of the WTG 22. The skilled person shall appreciate that similar principles apply in relation to each of the power units 22, 24, 25, and so specific methods for determining the possible power offset are not described in detail here to avoid obscuring the invention.

The PPC 34 therefore determines the deliverable power offset of each of the authorised power units 22, 24, 25, in step 108, as the minimum of: (i) the prescribed power offset for the frequency regulation service and (ii) the possible power offset that the power unit 22, 24, 25 is capable of providing.

In step 210, the PPC 34 may receive or otherwise determine a plant power offset request, specifying a total power offset from a baseline power level of the PP 12 to counteract the frequency deviation. The plant power offset request may be determined by one or more methods that are known to the skilled person in the art, which shall not be described in detail here to avoid obscuring the invention. It shall be appreciated though that the PPC 34 may, for example, use one or more of the look-up tables 102, or the P-f curves for the frequency regulation services defined therein, and thereby determine a respective plant power offset for counteracting the frequency deviation based on the measured frequency level.

In response to the plant power offset request, the PPC 34 determines and dispatches set points to the authorised power units 22, 24, 25 to cumulatively satisfy the plant power offset request, in step 212.

In this respect, the set points are determined for each of the authorised power units 22, 24, 25 in accordance with the prescribed power offsets for the measured frequency level, adhering to any agreed maximum power contributions and/or limits of possible power offsets.

However, in some cases, the PPC 34 may determine that a cumulative or total power offset produced by operating all of the authorised power units 22, 24, 25 in this manner would exceed the plant power offset request. The PP 12 would therefore overcompensate for the frequency deviation, which could lead to a frequency deviation above the nominal frequency level.

Accordingly, in step 212, the PPC 34 selects all or some of the authorised power units 22, 24, 25 to produce the deliverable power offset, determined in step 208, and determines set points for the remaining authorised power units 22, 24, 25 to cumulatively resolve (as much as possible) any outstanding shortage between the plant power offset request and the cumulative power offset provided by the selected power units 22, 24, 25.

The selection of power units 22, 24, 25 may be performed according to one or more suitable methods depending on respective aims of the power plant operator, which may be provided or defined by instructions sent to the PPC 34, for example.

In an example, the selection may be performed by prioritising those power units 22, 24, 25 that are able to deliver the greatest power offsets. In particular, the PPC 34 may rank the authorised power units 22, 24, 25 in a priority list based on the deliverable power offsets, determined in step 208, and select the 1 to M highest ranked power units, where M is determined as a maximum positive integer such that the cumulative/total power offset of the selected power units 22, 24, 25 is less than or equal to the plant power offset request. In other words, the PPC 34 may be configured to select as many of the highest-ranking power units 22, 24, 25 as possible, to provide the respective deliverable power offset, without the cumulative power offset exceeding the plant offset power request, and determine respective set points for the remaining authorised power units 22, 24, 25 to satisfy any outstanding power shortage.

For this purpose, the controller 100 of the PPC 34 may be arranged as shown in FIG. 5, for example, as shall be discussed in more detail below.

FIG. 5 shows a functional block diagram, illustrating additional non-limiting examples of how the power plant control method may be implemented.

FIG. 5 shows an arrangement in which PPC 34 provides frequency control by way of a respective frequency support module 402 for each power unit 22, 24, 25, a ranking module 403, and a master dispatcher 404. Each of the frequency support modules 402, the ranking module 403 and the master dispatcher 404 can be implemented in software, firmware, hardware, or any suitable combination thereof, as will be understood by the skilled person. Similarly, the described functionality can be distributed across any software, firmware and/or hardware modules, which can be distributed in any suitable way throughout a power generation network.

As shown in FIG. 5, each of the frequency support modules 402 may receive the measured frequency, f, and a baseline power command, P_{com}, for the respective power unit 22, 24, 25. Each frequency support module 402 may further receive one or more frequency regulations service authorisations, FCR, for that power unit 22, 24, 25, along with any agreed maximum power contributions thereto, P_{cont}, and any available power limits, P_{cap}, for the power unit 22, 24, 25.

In accordance with steps 204 to 208, each frequency module 402 may therefore determine whether the respective power unit 22, 24, 25 is authorised to provide a frequency regulation service in the frequency sub-band of the measured frequency, f. If the power unit 22, 24, 25 is not authorised to provide a frequency regulation service in the identified sub-band, the respective frequency module 402 may determine a deliverable power offset, ΔP_{del}, of zero, for example. However, if the power unit 22, 24, 25 is authorised to provide a frequency regulation service in the identified sub-band, the respective frequency module 402 may determine a power offset, ΔP_{del}, that is deliverable from that power unit 22, 24, 25 to counteract the frequency deviation. In particular, the respective frequency module 402 may determine a prescribed power offset, ΔPₛₑᵣᵥ, based on the authorised frequency regulation service, FCR, the measured frequency, f, and the agreed maximum power contributions thereto, P_{cont}, substantially as described previously. Furthermore that frequency module 402 may also determine a possible power offset, ΔPₚₒₛₛ, of the respective power unit 22, 24, 25 based on the baseline power command, P_{com}, for the respective power unit 22, 24, 25 and any available power limits, P_{cap}, for that power unit 22, 24, 25. Based on these determinations, the frequency module 402 may therefore determine the deliverable power offset, ΔP_{del}, as a minimum of the prescribed power offset, ΔPₛₑᵣᵥ, and the possible power offset, ΔPₚₒₛₛ.

In step 212, the deliverable power offset, ΔP_{del}, determined for each power unit 22, 24, 25 is delivered to the ranking module 403 which proceeds to determine a priority list, ranking the power units 22, 24, 25 based on the deliverable power offset, ΔP_{del}. The ranking module 403 may therefore output a respective ‘RANK’ associated with each power unit 22, 24, 25 to the master dispatcher 404.

The master dispatcher 404 further receives the baseline power command, P_{com}, and the deliverable power offset, ΔP_{del}, for each power unit 22, 24, 25, along with a plant offset request, ΔP_{ref}, for counteracting the frequency deviation.

The master dispatcher 404 therefore uses the received information to determine respective set points for each of the power units 22, 24, 25, in step 212. For example, the master dispatcher 404 may use the RANK and the deliverable power offset, ΔP_{del}, of each power unit 22, 24, 25 to select the 1 to M highest ranking power units 22, 24, 25 to provide the deliverable power offset, ΔP_{del}, where the master dispatcher 404 determines the integer M as the maximum number of power units 22, 24, 25 that may be operated in this manner without exceeding the plant offset power request, ΔP_{ref}. The set points for each of the 1 to M highest ranking power units 22, 24, 25 may therefore be determined based on the respective baseline power commands, P_{com}, and the respective deliverable power offsets, ΔP_{del}. The master dispatcher 404 may further determine the set points for each of the power units 22, 24, 25 having a zero deliverable power offset, ΔP_{del}, as equal to the baseline power command, P_{com}. Lastly, the master dispatcher 404 may determine set points for the remaining power units 22, 24, 25 according to one or more strategies to satisfy a power shortage, if any, between the cumulative power offset of the 1 to M highest ranking power units 22, 24, 25 and the plant offset power request, ΔP_{ref}. For example such strategies may determine set points that provide a power offset from as many of the remaining power units 22, 24, 25 as possible, or that maximises the power offset from the highest-ranking ones of those power units 22, 24, 25.

In this manner, the power units 22, 24, 25 are operated to counteract the frequency deviation and support the main grid in returning to the nominal operating frequency. It is expected that the methods and system of the present invention will therefore provide for enhanced grid stability and improved operational flexibility, allowing wider adoption of frequency regulation services within the frequency contingency deadband

It will be appreciated that various changes and modifications can be made to the examples described above without departing from the scope of the present invention.

For example, the frequency support method above can be implemented within any suitable control function or module associated with one or more power units or power plants. As well as a PPC 34, as described above, the frequency support method can be performed locally by respective controllers 32 of the power units 22, 24, 25. It can also be implemented in software, firmware, and/or hardware remotely from the PPC, and the required set points provided to the PPC for forwarding to its associated power plant.

Wherever the method is implemented, look-up tables or curves of P-f offset values can be accessed to determine a set point for controlling a power characteristic of the power plant. The look-up tables or curves may be accessed via a communications network, such as a wired or wireless IP-based network. Alternatively, the tables or curves of P-f offset values may be stored locally. Moreover, although P-f curves have been described above for respective frequency regulation services, or combinations thereof, it shall be appreciated that respective frequency regulation services may instead define respective offset curves from the baseline frequency curve for any defined sub-band(s).

The skilled person will appreciate that references to periods such as hours or days in the preceding paragraphs are examples only, and any other suitable time period or periods may be used depending upon the implementation.

1. A method of controlling a renewable energy power plant to provide frequency regulation for a power network, to which the power plant is connected, the power plant comprising a plurality of power units operable to provide upregulation or downregulation of the power network, the method comprising:
receiving a measured frequency level of the power network indicative of a frequency deviation within a frequency contingency deadband of the power network;
identifying a sub-band of the frequency deviation, from amongst a plurality of sub-bands within the frequency contingency deadband, based on the measured frequency level;
identifying one or more power units authorized for at least one frequency regulation service within the identified sub-band;
determining a deliverable power offset from a baseline power level for each authorised power unit, the deliverable power offset being based, in part, on the at least one authorised frequency regulations service; and
determining and dispatching power set points to the one or more authorised power units to satisfy a plant power offset request for the measured frequency level, the set points being determined by:
selecting one or more of the authorised power units to provide the deliverable power offset determined for that power unit, wherein a cumulative power offset of the one or more selected power units is less than or equal to the plant power offset request; and
if there is a power shortage between the plant power offset request and the cumulative power offset, determining set points for the remaining authorised power units to satisfy the power shortage.

2. The method according to claim 1, wherein the deliverable power offset is determined as a minimum of:
a prescribed power offset for that power unit, the prescribed power offset being based on the at least one authorised frequency regulation service and the measured frequency level; and
a possible power offset for that power unit, the possible power offset being a difference between the baseline power level for that power unit and an upper or lower limit of available power for that power unit.

3. The method according to claim 2, wherein each power unit is authorised for one or more of a plurality of frequency regulation services, each frequency regulation service being associated with prescribed power offsets for respective frequency levels within one or more of the plurality of sub-bands.

4. The method according to claim 3, wherein the plurality of frequency regulation services include one or more of:
a Frequency Containment Reserve for Normal Operation (FCR-N) in response to frequency deviations below a nominal frequency level of the power network;
a FCR-N in response to frequency deviations above the nominal frequency level;
a Frequency Containment Reserve for Disturbances (FCR-D) in response to frequency deviations below the nominal frequency level; or
a FCR-D in response to frequency deviations above the nominal frequency level.

5. The method according to claim 3, wherein each frequency regulation service is associated with a respective Power-frequency (P-f) curve; and wherein the method further comprises determining the prescribed power offset for each authorised power unit based on the P-f curve associated with the at least one authorised frequency regulation service.

6. The method according to claim 4, wherein each of the FCR-N and FCR-D frequency regulation services is associated with a respective P-f offset curve from a baseline power level in a respective sub-band of the frequency contingency deadband.

7. The method according to claim 6, wherein combinations of the FCR-N or FCR-D frequency regulation services are associated with respective P-f curves, the respective P-f curves being determined by summing the respective P-f offset curves of the combined FCR-N or FCR-D frequency regulation services.

8. The method according to claim 3, wherein each power unit is authorised for the one or more frequency regulation services for a respective service period.

9. The method according to claim 2, further comprising determining the prescribed power offset for each authorised power unit based on a respective agreed maximum contribution to the at least one authorised frequency regulation service.

10. The method according to claim 9, wherein the maximum contribution to the at least one authorised frequency regulation service is agreed for a prescribed service period.

11. The method according to claim 2, further comprising determining the possible power offset for the power unit based on the baseline power level for that power unit and the upper or lower limit of available power for that power unit.

12. The method according to claim 1, wherein the one or more authorised power units are selected by:
ranking the one or more authorised power units in a priority list based on the deliverable power offset determined for each authorised power unit; and
selecting the 1 to M highest ranked power units, where M is a positive integer.

13. The method according to claim 12, wherein M is a maximum positive integer for ensuring that the cumulative power offset of the one or more selected power units is less than or equal to the plant power offset request.

14. The method according to claim 1, wherein the plurality of power units include:
one or more renewable energy generators;
one or more energy stores; or
one or more energy consumers.

15. A power plant controller configured to perform the method of claim 1.
